(19) United States
(12) Patent Application Publication
(10) Pub. No.: US 2016/0292093 A1
(43) Pub. Date: Oct. 6, 2016

(54) BUS SYSTEM INCLUDING BRIDGE CIRCUIT FOR CONNECTING INTERLOCK BUS AND SPLIT BUS

(71) Applicant: FANUC Corporation, Minamitsuru-gun (JP)

(72) Inventors: Takaaki KOMATSU, Minamitsuru-gun (JP); Masahiro TSUJI, Minamitsuru-gun (JP)

(21) Appl. No.: 15/084,560

(22) Filed: Mar. 30, 2016

(30) Foreign Application Priority Data
Apr. 3, 2015 (JP) 2015-076509

(51) Int. Cl. G06F 13/16; G06F 13/42

(52) U.S. Cl. CPC G06F 13/1652; G06F 13/1673; G06F 13/1678; G06F 13/4282

(57) ABSTRACT

A bus system is configured by connecting an unretriable interlock bus and a split bus through first and second bridge circuits and respectively connecting first and second channels of the split bus and the interlock bus through the first and second bridge circuits. An access from the split bus side to the interlock bus side is processed by the first bridge circuit and an access from the interlock bus side to the split bus side is processed by the second bridge circuit, whereby a deadlock during a bus conflict is avoided.

### BACKGROUND OF THE INVENTION

1. Field of the Invention

The present invention relates to a bus system including a bridge circuit for connecting an interlock bus and a split bus.

2. Description of the Related Art

As an inter-chip bus and an on-chip bus inside an electronic device, there are an interlock bus that is occupied from an access request start to response completion and a split bus that enables execution of another access without being occupied between an access request and a response to the access request. As examples of split buses, there are PCI Express and AMBA AXI. As examples of interlock buses, there are PCI bus and AMBA APB. Therefore, a bridge circuit for connecting an interlock bus and a split bus is sometimes present on the inside of an electronic device.

A form in which, for example, two interlock buses are connected via a split bus using such a bridge circuit is assumed. When one interlock bus accesses the other interlock bus via the split bus and an access in the opposite direction simultaneously occurs, the interlock buses cannot respond to accesses from the split bus and a deadlock occurs. As a means for avoiding the deadlock, there is known a method of retrying the interlock buses and executing the access from the split bus earlier (see, for example, Japanese Patent Application Laid-Open No. 2001-060181, Japanese Patent Application Laid-Open No. 10-055341, Japanese Patent Application Laid-Open No. 09-212469, and Japanese Patent Application Laid-Open No. 09-204409).

However, the prior art cannot be applied when the interlock buses do not support retries. Even if the split buses support out-of-order transfer, a device or an IP core connected to the split buses sometimes cannot return a response (read data) to an inbound read request in a state in which the number of outbound access requests on hold exceeds a certain number.

### SUMMARY OF THE INVENTION

Therefore, it is an object of the present invention to provide a bus system that avoids a deadlock during a bus conflict in a bridge circuit for connecting a split bus and an unretriable interlock bus.

A bus system according to the present invention includes first and second bridge circuits for connecting a split bus and an interlock bus. The first bridge circuit connects the interlock bus and a first channel of the split bus. On the other hand, the second bridge circuit connects the interlock bus and a second channel of the split bus. An access from the split bus side to the interlock bus side is processed by the first bridge circuit through the first channel. On the other hand, an access from the interlock bus side to the split bus side is processed by the second bridge circuit through the second channel.

According to the present invention, it is possible to avoid a deadlock during a bus conflict in the bridge circuit for connecting the split bus and the unretriable interlock bus.

The first bridge circuit may include a buffer that receives access requests from the split bus side. The interlock bus may include a first arbitration circuit that arbitrates bus access rights of bus masters connected to the interlock bus. The first arbitration circuit may limit, according to the number of access requests retained by the buffer, the bus access rights of the bus masters of the interlock bus excluding the first bridge circuit.

According to this embodiment, since the interlock bus is arbitrated according to the number of access requests retained by the buffer, the bus system preferentially processes, on the first interlock bus, the access requests from the split bus side to the interlock bus accumulated in the buffer while avoiding a deadlock during a conflict of the interlock bus and the split bus. Therefore, it is possible to prevent access requests from being excessively accumulated in the buffer.

At least one of the bus masters of the interlock bus (a first interlock bus) may be a third bridge circuit for connecting the first interlock bus and another interlock bus (a second interlock bus) different from the first interlock bus. The second interlock bus may include a second arbitration circuit that arbitrates bus access rights of bus masters of the second interlock bus. The third bridge circuit may process an access from the first interlock bus to the second interlock bus and an access from the second interlock bus to the first interlock bus. The second arbitration circuit may limit, according to the number of access requests retained by the buffer, the bus access rights of the bus masters of the second interlock bus excluding the third bridge circuit.

According to this embodiment, when the first interlock bus is further connected to another second interlock bus, the second arbitration circuit limits the access from the second interlock bus to the first interlock bus. Therefore, the bus system reduces a load of the first interlock bus and preferentially processes, on the first interlock bus, access requests from the split bus side to the first interlock bus side accumulated in the buffer. Therefore, it is possible to prevent access requests from being excessively accumulated in the buffer.

The first arbitration circuit may limit, when the number of access requests retained by the buffer exceeds a first threshold, the bus access rights of the bus masters of the first interlock bus excluding the first bridge circuit and cancel the access limitation of the first interlock bus when the number of access requests retained by the buffer falls below a second threshold. On the other hand, the second arbitration circuit may limit, when the number of accesses retained by the buffer exceeds a third threshold, the bus access rights of the bus masters of the second interlock bus excluding the second bridge circuit and cancel the access limitation of the second interlock bus when the number of access requests retained by the buffer falls below a fourth threshold. In this case, the second threshold is equal to or smaller than the first threshold. The fourth threshold is equal to or smaller than the third threshold.

According to this embodiment, the bus system preferentially processes, on the first interlock bus, the access requests from the split bus side to the interlock bus side accumulated in the buffer by setting the second and fourth thresholds small while minimizing intervention in the arbitration by setting the first and third threshold large. Therefore, it is possible to prevent access requests from being excessively accumulated in the buffer.

### BRIEF DESCRIPTION OF THE DRAWINGS

The objects and the features explained above and other objects and features of the present invention will be made clear from the following explanation of embodiments with reference to the accompanying drawings. Among the figures:

FIG. 1 is a diagram showing the circuit configuration of a bus system according to a third embodiment of the present invention and is used for explaining the circuit configurations of bus systems according to first and second embodiments of the present invention;

FIG. 2 is a diagram showing the circuit configuration of a bus system according to a fourth embodiment of the present invention; and

FIG. 3 is a diagram showing the circuit configuration of a bus system according to a fifth embodiment of the present invention.

### DESCRIPTION OF THE PREFERRED EMBODIMENTS

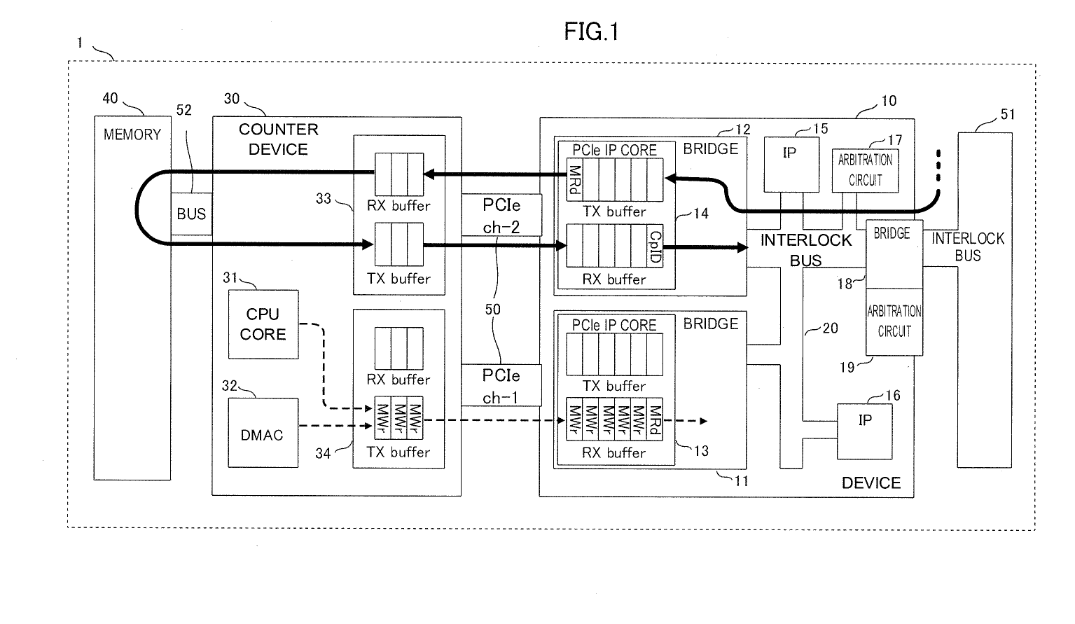

Bus systems according to first, second, and third embodiments of the present invention are explained with reference to FIG. 1.

First, the bus system according to the first embodiment of the present invention is explained.

The bus system according to this embodiment is a system that connects a device, an internal bus of which is configured by an interlock bus, to a counter device such as a CPU through a split bus on a printed board. Two bridge circuits for bridging the interlock bus and the split bus are provided in the interlock bus inside the device.

As shown in FIG. 1, a bus system 1 is configured by connecting a device 10, an internal bus of which is configured by an interlock bus 20, to a counter device 30 including a CPU core 31, a DMAC 32, and the like through a split bus 50 on a printed board. In the interlock bus 20 in the device 10, two bridge circuits 11 and 12 for connecting the interlock bus 20 and the split bus 50 are provided.

The first bridge circuit 11 is connected to the counter device 30 via one channel (a first channel) of the split bus 50. The second bridge circuit 12 is connected to the counter device 30 via another channel (a second channel) of the split bus 50.

An access from the split bus 50 side to the interlock bus 20 side is processed by the first bridge circuit 11 through the first channel. On the other hand, an access from the interlock bus 20 side to the split bus 50 side is processed by the second bridge circuit 12 through the second channel.

It is assumed here that a bridge circuit is connected to the counter device 30 only by one channel of the split bus 50. When a read request (or a non-posted write request with completion guarantee) from the interlock bus 20 side to the split bus 50 side occurs, access requests from the split bus 50 side to the interlock bus 20 side can occur. For example, if the access requests reach an upper limit of the number of uncompleted transactions (the number of outstanding transactions) of the split bus 50 or if a transmission buffer of the counter device 30 and a reception buffer of the bridge circuit are filled and no space is left, a read response (or a write completion notice) from the split bus 50 side to the interlock bus 20 side cannot be returned. When a read (or a non-posted write request with completion guarantee) from the interlock bus 20 side is not completed, since an access request from the split bus 50 side cannot exit to the interlock bus 20, a deadlock of the buses occurs.

In the circuit configuration of the bus system 1 shown in FIG. 1, the two bridge circuits 11 and 12 are provided in the interlock bus 20, the counter device 30 and the split bus 50 are connected by the two channels, and an access from the split bus 50 side to the interlock bus 20 side and an access from the interlock bus 20 side to the split bus 50 side are separated and respectively processed by the bridge circuits 11 and 12. Consequently, it is possible to surely avoid a deadlock during a bus conflict.

Here, an example is explained in which the first and second bridge circuits 11 and 12 and the counter device 30 are connected by the two channels of the split bus 50. However, there may be a plurality of channels for bridging accesses from the split bus 50 side to the interlock bus 20 side and a plurality of channels for bridging accesses from the interlock bus 20 side to the split bus 50 side. For example, it is conceivable that accesses from the split bus 50 side to the interlock bus 20 side is connected by two channels and two bridge circuits are implemented on the interlock bus 20 side to process the access. In this case, as a method of channel assignment, it is conceivable to assign high-priority accesses to one channel and low-priority accesses to the other channel.

In FIG. 1, an example is shown in which the device 10, the internal bus 20 of which is configured as the interlock bus, is connected to the counter device 30 by the split bus 50 on the printed board. However, it is unnecessary to divide the device 10 and the counter device 30. The inside of one device may be configured by buses of multiple stages. An entire bus system including two bridge circuits of an interlock bus and a split bus may be implemented in one device.

In the example explained above, an intra-device bus is the interlock bus and an inter-device bus is the split bus. However, conversely, the intra-device bus may be the split bus and the inter-device bus may be the interlock bus. Alternatively, both of the interlock bus and the split bus may be the inter-device buses and only the bridge circuit may be implemented inside the device.

Further, the counter device 30 is physically connected by the two channels. However, when the counter device 30 supports a function of realizing a plurality of logical channels with one physical channel, the function can also be used. As an example of such a function, there is a virtual channel of PCI Express. The PCI Express supports maximum eight virtual channels in standards. As an actual device, there is a product including a plurality of virtual channels. In this case, it is possible to avoid a deadlock during a bus conflict as explained above by using the plurality of virtual channels with physical connection using one channel.

Next, a bus system according to a second embodiment of the present invention is explained.

The basic configuration of the bus system according to this embodiment is the same as the basic configuration of the bus system according to the first embodiment. However, the bus system according to this embodiment is different from the bus system according to the first embodiment in that an arbitration circuit is added to the bus system.

In this embodiment, the first bridge circuit 11 includes a buffer that receives an access request from the split bus 50 side. As the buffer, as shown in FIG. 1, an RX buffer of a PCIe IP core 13, which is a component of the first bridge circuit 11, may be used. Alternatively, the buffer may be provided in the first bridge circuit 11 as another buffer.

The first interlock bus 20 includes a first arbitration circuit 17 that arbitrates bus access rights of bus masters connected to the first interlock bus 20. The first arbitration circuit 17 limits, according to the number of access requests retained by the buffer, the bus access rights of the bus masters of the first interlock bus 20 excluding the first bridge circuit 11.

With the configuration of this embodiment, since the first arbitration circuit 17 arbitrates the interlock bus 20 according to the number of access requests retained by the buffer, the bus system preferentially processes, on the first interlock bus 20, the access requests from the split bus 50 side to the interlock bus 20 accumulated in the buffer while avoiding a deadlock during a conflict of the interlock bus 20 and the split bus 50. Therefore, it is possible to prevent access requests from being excessively accumulated in the buffer.

Next, a bus system according to a third embodiment of the present invention is explained.

The basic configuration of the bus system according to this embodiment is the same as the basic configuration of the bus systems according to the first and second embodiments. However, the bus system according to this embodiment is different from the bus systems according to the foregoing embodiments in that another interlock bus and another arbitration circuit are added to the bus system in the second embodiment.

When at least one of the bus masters of the first interlock bus 20 is a third bridge circuit 18 for connecting the first interlock bus 20 and another (a second) interlock bus 51, the second interlock bus 51 includes a second arbitration circuit 19 that arbitrates bus access rights of bus masters of the second interlock bus 51.

The third bridge circuit 18 processes an access from the first interlock bus 20 to the second interlock bus 51 and an access from the second interlock bus 51 to the first interlock bus 20. The second arbitration circuit 19 limits, according to the number of access requests retained by the buffer, the bus access rights of the bus masters of the second interlock bus 51 excluding the third bridge circuit 18.

With the configuration of this embodiment, when the first interlock bus 20 is further connected to the other interlock bus 51, the second arbitration circuit 19 limits an access from the second interlock bus 51 to the first interlock bus 20. Therefore, the bus system reduces a load of the first interlock bus 20 and preferentially processes, on the first interlock bus 20, access requests from the split bus 50 side to the first interlock bus 20 side accumulated in the buffer. Therefore, it is possible to prevent access requests from being excessively accumulated in the buffer.

An operation example of the first arbitration circuit 17 and the second arbitration circuit 19 (an operation example of the first arbitration circuit 17 according to the second embodiment and the first and second arbitration circuits 17 and 19 according to the third embodiment) in the bus system 1 shown in FIG. 1 is explained.

When the number of access requests retained by the buffer exceeds a first threshold, the first arbitration circuit 17 limits the bus access rights of the bus masters of the first interlock bus 20 excluding the first bridge circuit 11. On the other hand, when the number of access requests retained by the buffer falls below a second threshold, the first arbitration circuit 17 cancels the access limitation of the first interlock bus 20.

When the number of access requests retained by the buffer exceeds a third threshold, the second arbitration circuit 19 limits the bus access rights of the bus masters of the second interlock bus 51 excluding the third bridge circuit 18. On the other hand, when the number of access requests retained by the buffer falls below a fourth threshold, the second arbitration circuit 19 cancels the access limitation of the second interlock bus 51.

The second threshold is set to be equal to or smaller than the first threshold. As values of the thresholds, depending on the number of buffers of the first bridge circuit 11, for example, when the number of buffers is N=128, the first threshold can be P=32 (<N) and the second threshold can be Q=2 (P).

Similarly, the fourth threshold is set to be equal to or smaller than the third threshold. As values of the thresholds, for example, the third threshold can be U=32 (<N) and the fourth threshold can be V=2(≦U).

Such setting can be applied to only one of the first arbitration circuit 17 and the second arbitration circuit 19 or may be applied to both of the first arbitration circuit 17 and the second arbitration circuit 19.

According to the operation example of the first and second arbitration circuits 17 and 19 explained above, the bus system preferentially processes, on the first interlock bus 20, the access requests from the split bus 50 side to the interlock bus 20 side accumulated in the buffer by setting the second and fourth thresholds small while minimizing intervention in the arbitration by setting the first and third threshold large. Therefore, it is possible to prevent access requests from being excessively accumulated in the buffer.

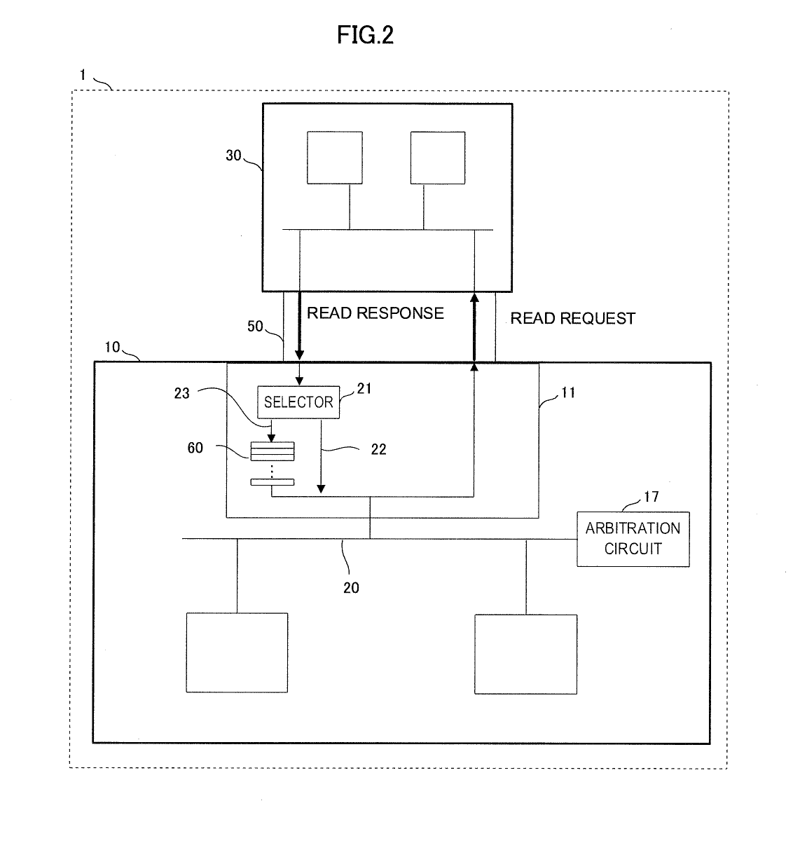

A bus system according to a fourth embodiment of the present invention is explained with reference to FIG. 2.

FIG. 2 is a simple circuit configuration diagram of the bus system according to this embodiment. In FIG. 2, components corresponding to the components shown in FIG. 1 are denoted by the same reference numerals.

In this embodiment, the bridge circuit 11 for bridging the split bus 50 and the first interlock bus 20 includes a first route 22 for always processing a read response to a read request from the interlock bus 20 side to the split bus 50 side and for processing an access request (a target address and write data) generated from the split bus 50 side when there is no read request from the interlock bus 20 side to the split bus 50 side. The bridge circuit 11 also includes a second route 23 for processing an access request generated from the split bus 50 side when there is a read request from the interlock bus 20 side to, the split bus 50 side. The first route 22 and the second route 23 are selected by a selector circuit 21.

The bridge circuit 11 includes, in the second route 23, a buffer 60 that saves an access request generated from the split bus 50 side when there is a read request from the interlock bus 20 side to the split bus 50 side. A size N of the buffer is desirably set to twice or more of a maximum number of access requests saved in the buffer while waiting one read response. Depending on a system configuration, for example, the size N is 128.

In the bus system 1 according to this embodiment, when there is a read request from the interlock bus 20 to the split bus 50, an access request received from the split bus 50 is saved in the buffer 60 provided on the second route 23 until a response (read data) from the split bus 50 is received. From the viewpoint of a device or an IP core on the split bus 50 side, when the access request is saved in the buffer 60, the access request is completed on the split bus 50 and is not in a suspended state. Therefore, when receiving the read request, the device or the IP core on the split bus 50 side can return a response (read data). The bridge circuit 11 receives the response from the split bus 50 and returns the response to the interlock bus 20. After the interlock bus 20 is released, the bridge circuit 11 accesses the interlock bus 20 according to the access request from the split bus 50 saved in the buffer 60.

As shown in FIG. 2, the interlock bus 20 includes the first arbitration circuit 17 that arbitrates bus access requests from a plurality of bus masters connected to the first interlock bus 20. The first arbitration circuit 17 performs arbitration of the interlock bus 20 to limit an access from the interlock bus 20 side and prioritize an access to the interlock bus 20 side according to the number of access requests from the split bus 50 side saved in the buffer.

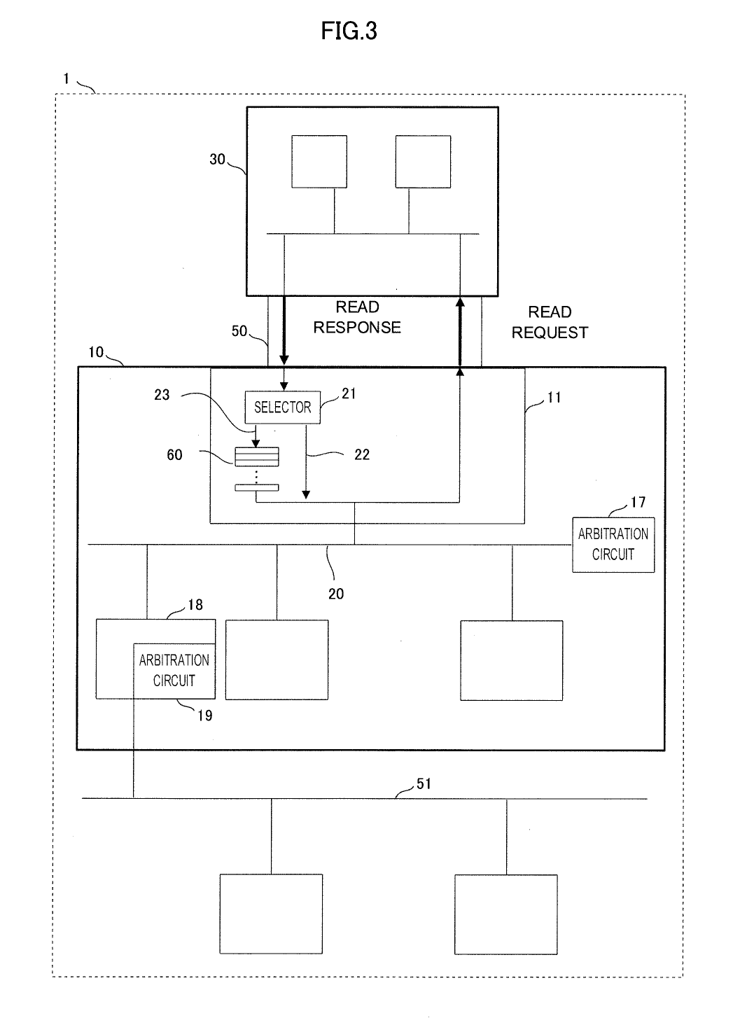

A bus system according to a fifth embodiment of the present invention is explained with reference to FIG. 3.

The bus system in this embodiment includes, as shown in FIG. 3, the third bridge circuit 18 for connecting the first interlock bus 20 and the second interlock bus 51 on the outside of the device 10 and the second arbitration circuit 19 that arbitrates the second interlock bus 51. The second arbitration circuit 19 performs arbitration to limit an access from the second interlock bus 51 to the first interlock bus 20 and reduce an occupancy rate of the first interlock bus 20 according to the number of access requests from the split bus 50 side saved in the buffer 60 (a buffer for an access request other than a read response).

In the bus system 1 shown in FIG. 3 including such a configuration, when the number of access requests saved in the buffer 60 provided on the second route 23 in the bridge circuit 11 exceeds the first threshold set in advance, the first arbitration circuit 17 limits bus access rights of the bus masters of the first interlock bus 20 excluding the first bridge circuit 11. On the other hand, when the number of access requests saved in the buffer 60 provided on the second route 23 in the bridge circuit 11 decreases to be smaller than the second threshold set in advance, the first arbitration circuit 17 cancels the access limitation of the first interlock bus 20.

The second threshold is set smaller than the first threshold. For example, the first threshold is set to P=32 (<N) and the second threshold is set to Q=2 (<P).

Similarly, when the number of access requests saved in the buffer 60 provided on the second route 23 in the bridge circuit 11 exceeds the third threshold set in advance, the second arbitration circuit 19 limits bus access rights of the bus masters of the second interlock bus 51 excluding the third bridge circuit 18. When the number of access requests saved in the buffer 60 in the bridge circuit 11 decreases to be smaller than the fourth threshold set in advance, the second arbitration circuit 19 cancels the access limitation of the second interlock bus 51.

The fourth threshold is set smaller than the third threshold. For example, the third threshold is set to U=32 (<N) and the fourth threshold is set to V=2 (<U).

Such setting can be applied to only one of the first arbitration circuit 17 and the second arbitration circuit 19 or may be applied to both of the first arbitration circuit 17 and the second arbitration circuit 19.

The embodiments of the present invention are explained above. However, the present invention is not limited to only the examples of the embodiments explained above and can be carried out in various forms by adding appropriate changes to the embodiments.

What is claimed is:

1. A bus system having bridge circuits for connecting a split bus and an interlock bus, the bridge circuits being a first bridge circuit and a second bridge circuit, wherein
the first bridge circuit connects the interlock bus and a first channel of the split bus,
the second bridge circuit connects the interlock bus and a second channel of the split bus,
an access from the split bus side to the interlock bus side is processed by the first bridge circuit through the first channel, and
an access from the interlock bus side to the split bus side is processed by the second bridge circuit through the second channel.

2. The bus system according to claim 1, wherein
the first bridge circuit includes a buffer that receives an access request from the split bus side,
the interlock bus includes a first arbitration circuit that arbitrates bus access rights of bus masters connected to the interlock bus, and
the first arbitration circuit limits, according to the number of access requests retained by the buffer, the bus access rights of the bus masters of the interlock bus excluding the first bridge circuit.

3. The bus system according to claim 2, wherein
at least one of the bus masters of a first interlock bus, which is the interlock bus, is a third bridge circuit for connecting the first interlock bus and a second interlock bus, which is another interlock bus different from the first interlock bus,
the second interlock bus includes a second arbitration circuit that arbitrates bus access rights of bus masters of the second interlock bus,
the third bridge circuit processes an access from the first interlock bus to the second interlock bus and an access from the second interlock bus to the first interlock bus, and
the second arbitration circuit limits, according to the number of access requests retained by the buffer, the bus access rights of the bus masters of the second interlock bus excluding the third bridge circuit.

4. The bus system according to claim 3, wherein
the first arbitration circuit limits, when the number of access requests retained by the buffer exceeds a first threshold, the bus access rights of the bus masters of the first interlock bus excluding the first bridge circuit and cancels the access limitation of the first interlock bus when the number of access requests retained by the buffer falls below a second threshold,
the second arbitration circuit limits, when the number of accesses retained by the buffer exceeds a third threshold, the bus access rights of the bus masters of the second interlock bus excluding the second bridge circuit and cancels the access limitation of the second interlock bus when the number of access requests retained by the buffer falls below a fourth threshold, and
the second threshold is equal to or smaller than the first threshold and the fourth threshold is equal to or smaller than the third threshold.
